(19) United States
(12) Patent Application Publication
(10) Pub. No.: US 2008/0258508 A1
(43) Pub. Date: Oct. 23, 2008

(54) Wind Deflector for a Sliding Roof

(76) Inventors: Jadolah Karami-Malamiri, Ottobrunn (DE); Cornelia Wertenbroch, Geltendorf (DE); Stefan Groitl, Neuried (DE); Christian Gallner, Holzkirchen (DE)

Correspondence Address: DICKINSON WRIGHT PLLC, 1901 L. STREET NW, SUITE 800, WASHINGTON, DC, 20036, US

(21) Appl. No.: 11/917,596

(22) PCT Filed: Jun. 13, 2006
(86) PCT No.: PCT/DE06/01015

§ 371 Date: Dec. 14, 2007

(30) Foreign Application Priority Data
Jun. 14, 2005 (DE) 10 2005 027 450.1

(51) Int. Cl. B60J 7/22

(52) U.S. Cl. 296/217

(57) ABSTRACT

The invention relates to a extendable wind deflector for a sliding roof of a motor vehicle, which comprises a wind deflector profile (15) provided with at least one air guiding wall (16). Said profile is open along the longitudinal extension thereof in at least one area which is oriented away from the air guiding wall (16) and comprises a sealing device (29) along the longitudinal extension thereof which co-operates with the roof section (8) of the vehicle body in at least one operational position. The at least one open area of the wind deflector profile (15) is covered by means of a covering device (25), such that a wind deflector (10) is obtained with a profile which is closed in the cross-section.

The invention relates to a wind deflector for a sliding roof, particularly of a motor vehicle, according to the preamble of Claim 1.

Such a wind deflector is known from DE 102 06 091 A1. This wind deflector presents an air guiding wall which, during operation, faces an air flow, and which possesses a sealing device which works in cooperation with a section of a roof skin. Depending on the driving speed, however, it is necessary to extend the wind deflector in a superelevated position, in which the sealing device no longer works in cooperation with the skin roof. In that case, wind also flows around the bottom side of the wind deflector. With a wind deflector according to DE 102 06 091 A1, undesired flow-generated noise is generated such a case.

From DE 103 12 286 A1, a wind deflector is known which presents a closed standardized support profile, on which a wind deflector profile with multiple openings in cross section can be stuck. In certain operating positions, such a wind deflector generates disturbing wind noises.

From U.S. Pat. No. 4,662,671, a wind deflector is known with a wind deflector profile which is open on one side in cross section. The wind deflector profile according to U.S. Pat. No. 4,662,671 is mounted rigidly by means of an attachment rail to the vehicle roof. One side, which is turned away from the air guiding wall of the wind deflector according to U.S. Pat. No. 4,662,671, is not exposed to wind flowing around it in any operating position. The disadvantage of such a wind deflector is that it is mounted rigidly to the vehicle roof, i.e., its height cannot be adjusted variably.

The problem of the invention is to provide an extendable wind deflector with which, in each operating position, the generation of noises due to wind flow against and/or around the wind deflector profile are minimized. In particular, the wind deflector should be extendable for larger sliding roofs or larger roof openings over a roof skin to prevent rumbling noises, while at the same time generating only slight noise due to flow. In addition, it should be possible to manufacture such a wind deflector at low cost and with few parts, so that the installation and/or logistics costs are minimized.

This problem is solved with a wind deflector having the characteristics of Claim 1. Advantageous embodiments are indicated in the dependent claims.

A special advantage of the wind deflector according to the invention is that a sealing device is present which, in a partially extended position, works in cooperation with the roof skin, thus ensuring that air flows against only one air guiding wall. In this way, noise generation is minimized in such an operating position. In a second, farther extended, operating position, air flows both against the air guiding wall and also against an area which is turned away from the air guiding wall, where the area that is turned away is covered with a covering device, so that in this position as well noise generation due to wind noises is minimized because the wind deflector has a profile that is closed in cross section.

According to a particularly preferred embodiment, the covering device is designed in the shape of plates, and attached to the wind deflector profile without the use of additional securing means in the form of parts that are separate before the installation. This reduces the installation and logistics cost. In addition, interfering edges of the fastening means (screws) can be avoided, which contributes further to noise reduction. Advantageously, clinch devices are molded on the wind deflector profile, which devices, in the mounted state, penetrate through the covering device and are deformed by cold or heat exchange processes.

It has been found to be particularly advantageous to connect the covering device to the wind deflector profile by welding or clip connection. A clamping plug connection with clamping pins has also been shown to be appropriate. The clamping pins are designed so that they have the shape of a Christmas tree in cross section, with deformable clamp protrusions.

In an additional advantageous embodiment, the sealing device is connected to form one piece with the covering device, which has the consequence that the number of components required for the assembly of the wind deflector is reduced even more. The sealing device, as a soft-part seal, is preferably formed on the covering device to constitute a single piece, for example, by the two-component injection molding technique.

The invention is explained in greater detail below using an example with reference to the drawing. The drawing shows:

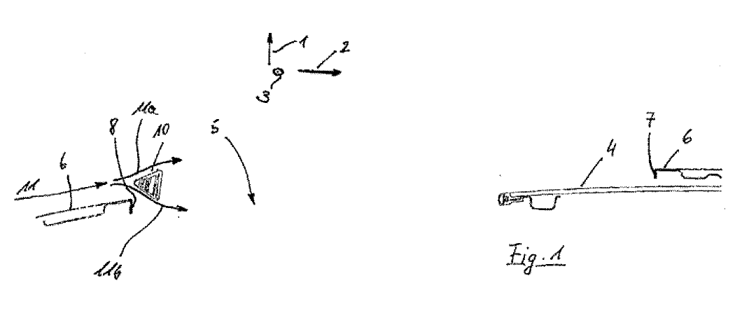

FIG. 1: A cross section through a central longitudinal section through a vehicle roof with a wind deflector according to the invention and a partially opened sliding roof;

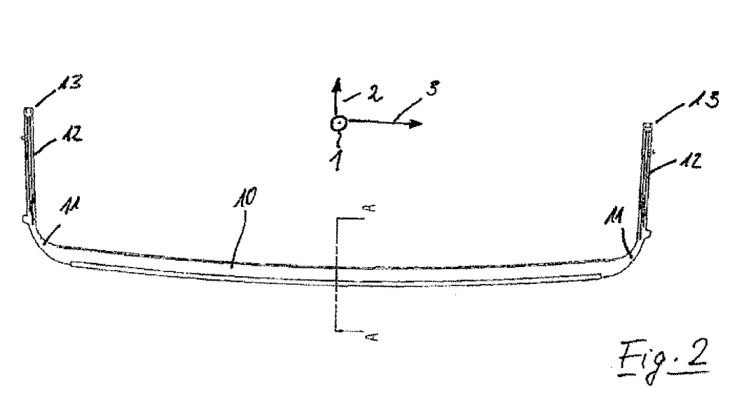

FIG. 2: a wind deflector according to the invention in a top view;

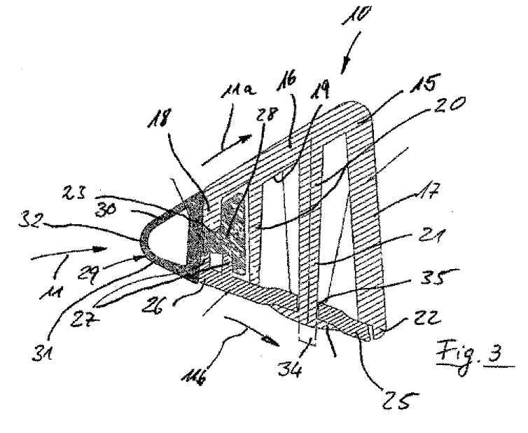

FIG. 3: a cross-sectional view of a first embodiment of the wind deflector according to the invention along the cross section line A-A of FIG. 2;

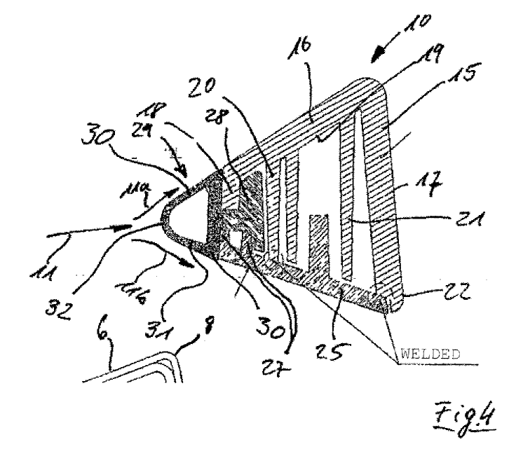

FIG. 4: An additional embodiment of the wind deflector according to the invention in a cross section along the line A-A of FIG. 2;

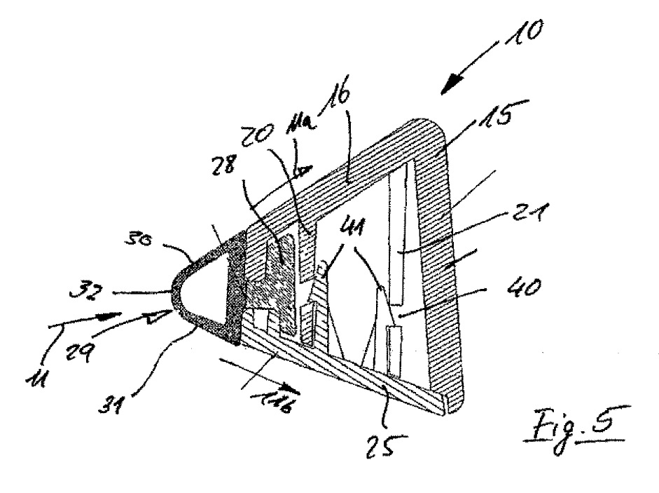

FIG. 5: An additional embodiment of the wind deflector according to the invention in a cross section along the cross-sectional line A-A of FIG. 2; and

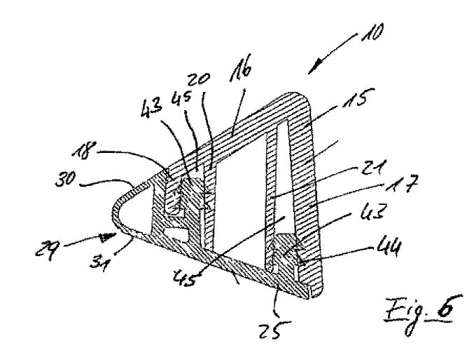

FIG. 6: an additional embodiment of the wind deflector according to the invention in a cross section along the line AA of FIG. 2.

For the continuation of the description, a Z-direction 1 is defined as the direction along the vehicle's vertical axis, an X-direction 2 is defined as a direction along the vehicle's longitudinal axis, and a Y-direction 3 is defined as the direction along the direction transverse to the vehicle.

FIG. 1 shows a central longitudinal section through a roof area of a vehicle, which is equipped with a sliding roof 4. The sliding roof 4 opens roof openings 5 of a [sic] during the opening of a roof skin 6. The roof opening 5 possesses a rear opening edge 7, located in the back, viewed in the driving direction (X-direction 2), and a front opening edge 8, located in the front, viewed in the driving direction. A wind deflector 10 according to the invention is arranged in the area of the front opening edge 8, and it is connected to the vehicle roof in a way which allows height adjustment in the Z-direction 1. When the sliding roof 4 is closed, the wind deflector 10 is arranged beneath the sliding roof, and it is extended in the Z-direction 1 when the sliding roof 4 is open.

In a top view (FIG. 2), the wind deflector 10 extends in the vehicle's transverse direction (Y-direction 3) over approximately the entire width of a roof opening 5. In the area of its ends 11, pivoting arms 12 are formed on the wind deflector 10, which arms are attached in the area of the free ends 13 about an axle which can be pivoted parallel to the Y-direction 3 with respect to the roof. In a top view, the wind deflector 10 according to the invention thus has a U-shaped spatial shape. During operation, an air flow 11 flows against the wind deflector 10 (see FIG. 1). If the wind deflector 10 is extended sufficiently in the Z-direction 1 so that it extends over the roof skin 6, the air flow 11 is divided into an upper flow 11a and a lower flow 11b.

Below, different embodiments of the wind deflector 10 according to the invention are described in greater detail with reference to FIGS. 3-6. Identical components are labeled with identical reference numerals.

The wind deflector 10 according to the invention, in a first embodiment (FIG. 3), possesses a wind deflector profile 15 with an air guiding wall 16 for guiding the upper flow 11a. A back wall 17, which is turned away from the air flow 11, is shaped on the air guiding wall 16.

In the area of the free end of the air guiding wall 16, which end faces the air flow 11, a first stop 18 is formed on the air guiding wall 16, where the stop 18 points, starting from the air guiding wall 16, in the same direction as the back wall 17.

In the area between the stop 18 and the back wall 17, stiffening ribs 20 are molded on an internal side 19 of the air guiding wall 16. Thus, the wind deflector profile 15 of the wind deflector 10 according to the invention presents an open wind deflector profile 15, where an area, which is turned away from the air guiding wall 16, is designed to be open between a free end 22 of the back wall 17 and a free end 23 of a first stop 18. Covering this open area, a substantially plate-shaped covering device 25 is arranged, which, in cross section, extends from the free end 22 of the back wall 17 to the free end 23 of the first stop 18. At the free end 26 of the covering device, which faces the air flow 11, from the covering device 25 on, supports 27 extend some distance in the direction towards the air guiding wall 16, where, between the supports 27 and the first stop 18 of the air guiding wall 16, a slit-shaped opening is formed, in which a sealing foot 28 of a sealing device 29 is held by clamping.

The sealing foot 28 is formed on the sealing device 29, which possesses a spatial shape which is hood-shaped in cross section, where a first sealing wall 30 in a mounted state is aligned with the air guiding wall 16, a second sealing wall 31 in the mounted state is aligned with the covering device 25, and the sealing walls 30 and 31 are interconnected by a bent wall section 32. The sealing device 29 is preferably designed as a soft-rubber seal. The sealing device 29, particularly of the bent wall section 32, can work in cooperation, so it forms a seal, with the front edge 8 of the roof opening 5 in at least one operating position.

In the first embodiment according to FIG. 3, at least one rib 21 is provided, extending away from the air guiding wall 16, with one or more clinch devices 34. The clinch devices 34 are preferably designed as clinch pins or clinch ledges, and it penetrates through a corresponding recess 35 in the covering device 25. After arranging the covering device 25 on the wind deflector profile 15, the clinch devices 34 are deformed by means of substantially known cold and/or warm clinch processes, so that a clinch head 36 is formed, whose external sides are substantially flush with an external side of the covering device 25.

In the area of the clinch head 36, the covering device 25 is shaped so that it penetrates through to the interior of the profile, so that the clinch head 36 ends approximately with the external side of the covering device 25.

Thus, the wind deflector 10 according to the invention, in the finished, installed state, presents a profile that is closed in cross section, which allows the lower flow 11b to flow over the second wall, which is aligned with the covering device 25, along the wind deflector 10 without substantial noise generation. The covering device 25 thus presents a second air guiding wall.

A second embodiment of the wind deflector 10 according to the invention is represented in FIG. 4. In contrast to the embodiment according to FIG. 3, the covering device 25 is designed so that its external side is completely smooth, and welded in the contact area of the covering device 25 with free ends 22 of the back wall 17, and also in a contact area between the rib 20 and the internal side of the covering device 25, for example, by ultrasound welding or similar procedures. In this embodiment, a completely smooth external side of the covering device 25 is achieved, so that a further improved noise minimization is achieved. For the rest, the embodiment of the wind deflector 10 according to the invention according to FIG. 4 corresponds substantially to the above described embodiment according to FIG. 3.

In this embodiment, the rib 21 presents preferably no clinch devices 34 and its design is shortened in comparison to the rib 20 of the embodiment according to FIG. 3.

FIG. 5 shows, in cross section, an additional embodiment of the wind deflector 10 according to the invention, where the covering device 25 is attached by means of a clip connection to the wind deflector profile 15. For this purpose, the ribs 21 and 20 present latch openings 40, in which the spring-mounted latches 41, which are connected to form one piece to the covering device 25, and can be engaged in or are engaged from the interior of the covering device in the direction towards the air guiding wall 16. In this embodiment, it is particularly advantageous that the wind deflector 10 according to the invention without additional machine effort, by clipping the covering device 25 in the wind deflector profile 15, the sealing device is insertable by clamping and thus attachable [sic]. This embodiment as well has a completely smooth external side of the covering device 25, so that a low noise generation is achieved when air flows against it.

FIG. 6 shows an additional embodiment of the wind deflector 10 according to the invention, in which the covering device 25 are inserted by clamping in the wind deflector profile 15. For this purpose, the covering device presents pin plugs 43, which extend from the internal side of the covering device some distance towards the air guiding wall 16. The pin plugs 43 possess, in cross section, clamping edges 44 that are shaped like a Christmas tree, and are made preferably of an easily deformable material, for example, a soft rubber. In this embodiment example, the wind deflector profile is adapted to the pin plugs 43 so that insertion shafts or insertion openings 45, into which the pin plugs 43 can be inserted by clamping, are formed between the rib 21 and the back wall 17, and between the rib 20 and the stop 18.

Furthermore, in the embodiment according to FIG. 6, the sealing device 29 is connected to form one piece with the covering device 25, where the sealing wall 31 is also aligned with the external side of the covering device 25, and, in the mounted state, the sealing wall 30 is aligned with the air guiding wall 16. Connecting the sealing device 29 to the covering device 25 in such a way that one piece is formed has the special advantage that the number of parts to be mounted is reduced further. The wind deflector according to the invention can be assembled by simply plugging the covering device 25 with a sealing device 29, which is formed to constitute one piece, and the wind deflector profile 15. This decreases the installation and logistics costs considerably.

In addition, the sealing device 29 can also be connected to form one piece to the wind deflector profile 15.

Naturally, the fastening variant of the covering device 25 for fastening to the wind deflector profile 15, which variant was described in connection with the embodiment according to FIG. 6, can also be used in the embodiments according to FIGS. 3-5 with a sealing device 29 which is not formed as a single piece. Furthermore, it is also possible naturally, in the fastening variants described in connection to FIGS. 3-5, to design the sealing device 29 so it forms one piece with the covering device 25, as described in connection with FIG. 6. The fastening variants of the embodiment examples can also be combined with each other without problem.

In the extendable wind deflector according to the invention it is particularly advantageous that, on the one hand, the noise generation by wind flowing against the wind deflector, particularly by wind flowing along the top and bottom sides of the wind deflector, is considerably reduced, in comparison to wind deflectors known from the state of the art, while the installation and logistics costs can be kept low, so that the wind deflector according to the invention can be manufactured cost effectively and in a simple way.

### LIST OF REFERENCE NUMERALS

1 Z-direction.
2 X-direction.
3 Y-direction.
4 sliding roof.
5 roof opening.
6 roof skin.
7 rear opening edge.
8 front opening edge.
10 wind deflector.
11 air flow.
11a upper flow.
11b lower flow.
15 wind deflector profile.
16 air guiding wall.
17 back wall.
18 stop.
19 internal side.
20 stiffening rib.
21 stiffening rib.
22 free end.
23 free end.
25 covering device.
26 free end.
27 free end.
28 sealing foot.
29 sealing device.
30 first sealing wall.
31 second sealing wall.
32 bent wall section.
34 clinch devices.
35 recess.
36 clinch head.
40 latch opening.
41 spring arm.
43 pin plugs.
44 clamp edge.
45 insertion openings.

1. Extendable wind deflector, for example, for a sliding roof of a motor vehicle, which comprises a wind deflector profile (15) provided with at least one air guiding wall (16), where the wind deflector profile (15) presents, along its longitudinal extent in at least one area turned away from the air guiding wall (16), and along its longitudinal extent, a sealing device (29), which works in cooperation, in at least one operating position, with a roof section (8) of a vehicle body, characterized in that the at least one open area of the wind deflector profile (15) is covered by a covering device (25), so that a wind deflector (10) with a closed profile in cross section is formed.

2. Wind deflector according to claim 1, characterized in that the covering device (25) is connected to the wind deflector profile (15) without additional securing means in the form of individual parts.

3. Wind deflector according to claim 1 and/or 2, characterized in that the covering device (25) is welded to the wind deflector profile (15).

4. Wind deflector according to one of the preceding claims, characterized in that the covering device (25) is connected by means of clinch devices (34) and cold and/or warm clinching to the wind deflector profile (15).

5. Wind deflector according to one of the preceding claims, characterized in that the covering device (25) is connected by means at least one clip connection (40, 41) to the wind deflector profile (15).

6. Wind deflector according to one of the preceding claims, characterized in that the covering device (25) is connected by means of at least one clamping plug connection, with friction connection and/or positive connection, to the wind deflector profile (15).

7. Wind deflector according to one of the preceding claims, characterized in that the sealing device 29) is connected forming one piece to the covering device (25), or it is connected forming one piece to the wind deflector profile (15).

8. Wind deflector according to one of the preceding claims, characterized in that the sealing device (29) is held by clamping between the wind deflector profile (15) and the covering device (25), particularly by clamping with positive connection.

9. Wind deflector according to one of the preceding claims, characterized in that the covering device (25) forms, in at least, one operating position of the wind deflector (10), a second air guiding wall.

10. Wind deflector according to one of the preceding claims, characterized in that the sealing device (29) presents sealing walls (30, 31) which are aligned with the corresponding air guiding wall (16) and/or with the covering device (25), so that, for an air flow 11, an upper flow 11a or a lower flow 11b, a substantially smooth and thus low-noise guidance or directing of air is ensured.
